(19) United States
(12) Patent Application Publication
(10) Pub. No.: US 2016/0254556 A1
(43) Pub. Date: Sep. 1, 2016

(54) Method and Device for Enhancing Fuel Cell Lifetime

(71) Applicants: Yong ZHANG, Beijing (CN); Wei MA, Beijing (CN); Zhigang QI, Schenectady, NY (US)

(72) Inventors: Yong ZHANG, Beijing (CN); Wei MA, Beijing (CN); Zhigang QI, Lexington, MA (US)

(21) Appl. No.: 15/033,621

(22) PCT Filed: Jan. 24, 2014
(86) PCT No.: PCT/CN2014/000091

§ 371 Date: Apr. 29, 2016

(30) Foreign Application Priority Data
Oct. 30, 2013 (CN) 201310523533.3

(51) Int. Cl. H01M 8/04223; H01M 8/04303; H01M 8/04746; H01M 4/92; H01M 8/241; H01M 8/2457; H01M 8/1004; H01M 8/04228; H01M 8/04955

(52) U.S. Cl. CPC H01M 8/04231; H01M 8/04228; H01M 8/04303; H01M 8/04753; H01M 8/04955; H01M 8/241; H01M 8/2457; H01M 8/1004; H01M 4/926; H01M 2008/1095

(57) ABSTRACT

A method for enhance lifetime of fuel cells via a device includes a step of creating a H₂ environment for a stack, wherein the H₂ environment is composed of H₂ confined within a gas-tight enclosure of the device. The device includes an enclosure-H₂-inlet port, an enclosure-H₂-outlet port, a stack-H₂-inlet, a stack-H₂-outlet, a stack-air-inlet, a stack-air-outlet, a stack-coolant-inlet, and a stack-coolant-outlet. The device prevents air from getting into the stack when the fuel cell system is in the idling or shutdown state. It solves the problems associated with the electrode damage caused by the open circuit voltage in the entire fuel cell non-operational time period and the electrode damage caused by the formation of an air/hydrogen boundary during either the startup or shutdown process. The device eliminates the damages of the open circuit voltage to either MEAs or stacks during their storage time period.

### CROSS REFERENCE OF RELATED APPLICATION

This is a non-provisional application that claims priority to international application number PCT/CN2014/000091, international filing date Jan. 24, 2014, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

This invention relates to fuel cells, particularly to method and device to eliminate the damages to the fuel cells caused by the open circuit voltage (OCV) in the fuel cell non-operational time period and by the formation of oxidizer/fuel boundaries during the fuel cell startup and shutdown processes and thus to enhance the fuel cell lifetime; and to method and device to eliminate the damages to membrane electrode assemblies and stacks by the OCV during their storage time period.

2. Description of Related Arts

Durability is most challenging in the development of all kinds of fuel cells. For commercialization fuel cells have to achieve lifetimes comparable to those of the traditional technologies. The US Department of Energy has set the fuel cell lifetime targets ranging from 1,500 to 60,000 hours for different applications.

The durability of a fuel cell is affected by many factors, including the materials themselves, the operational condition, the control strategy, and the design of the system. The operational condition includes temperature, relatively humidity, pressure, contaminants, reactant stoichiometric ratio, temperature cycling, relative humidity (RH) cycling, voltage cycling, open circuit voltage (OCV), and formation of an oxidizer/fuel boundary (such as O₂/H₂ boundary) at the electrode. With careful design and engineering and proper control algorithm the impacts of temperature, relative humidity, pressure, contaminants, reactant stoichiometric ratio, RH cycling, and temperature cycling can be avoided or controlled. However, the detrimental impacts of the OCV and the oxidizer/fuel boundary have not been satisfactorily resolved to date.

After a fuel cell gets into either the idling or the shutdown state, i.e., the non-operational state during which the fuel cell system does not provide power to the external load, each unit cell within a stack will have an OCV around 1 V. Air (example oxidizer) remaining in the cathode chamber and H₂ (example fuel) remaining in the anode chamber gradually diffuse through the electrolyte such as the proton exchange membrane (PEM) in a PEMFC to the other chamber, where O₂ from air will chemically react with H₂ to form water according to Reaction (1), which lowers the pressure inside both chambers accordingly.

H₂+0.5O₂=H₂O (1)

The diffusion rates are higher through thinner (or poorly manufactured) PEM, at higher temperatures, and with higher reactant pressures. The fluxes of H₂ and O₂ through the PEM can be easily estimated by using the Fick's first law of diffusion, J=−D dc/dx, where D and dc/dx are the diffusion coefficient and the concentration gradient of the diffusing species. The absolute pressures within the anode chamber and the cathode chamber can drop much lower than the ambient pressure in 10s minutes. For example, the pressure of the chambers may drop to as low as 0.5 bara in 15 minutes. The lower pressures within the chambers will facilitate the diffusion of air from the environment into the stack. Finally, both the anode and the cathode chambers are filled with air, and its final pressure reaches the ambient pressure. Although the OCV between the cathode and the anode of each unit cell is 0 V, the potentials at the anode/PEM and the cathode/PEM interfaces are both around 1 V determined by Reaction (2), as shown in FIG. 1.

0.5O₂+2H⁺+2e⁻=H₂O E°=1.2 V (2)

Therefore, minutes after a fuel cell system enters the non-operational state, the anode/PEM and the cathode/PEM interfaces are both around 1 V, which cause faster aging of the electrode components such as the Pt catalyst particles and the carbon supports, and thus shortens the lifetime of the electrodes. A fuel cell will be in the non-operational state for most of the time when it is used as the power source for transportation applications, backup applications, and portable applications, and thus the cumulative impact of the OCV during the non-operational state is severe and can dramatically shorten the lifetime of the fuel cell system. That a stack decays faster when not in operation than when in operation is a very disturbing fact, and has not been resolved to date.

Similarly, the OCV also affects the performance and lifetime of a membrane electrode assembly (MEA) during its storage time period. After an MEA is prepared but not assembled into a stack, it is normally exposed to the ambient environment that is filled with air. The potentials at both the anode/PEM and the cathode/PEM interfaces are both around 1 V, which cause faster aging of the electrode components such as the Pt catalyst particles and the carbon supports.

The OCV also affects the performance and lifetime of a stack during its storage time period. After a stack is made but not installed into a fuel cell system, it is typically exposed to the ambient environment and thus both the anode chamber and the cathode chamber are filled with air. The potentials at both the anode/PEM and the cathode/PEM interfaces of each unit cell are around 1 V, which cause faster aging of the electrode components such as the Pt catalyst particles and the carbon supports.

What is worse is the formation of an oxidizer/fuel boundary such as an O₂/H₂ boundary on the electrode surface. The formation of such a boundary can severely lower the performance and the durability of each MEA and thus shorten the lifetime of a fuel cell. Such a boundary forms easily at the anode after the fuel cell is shut down after which air from the environment slowly diffuses into the anode chamber that still contains unreacted H₂; and during the fuel cell startup when H₂ enters the anode chamber this is already filled with air in the non-operational time period. As shown by FIG. 2, when O₂ diffuses into the anode that contains the remaining unreacted H₂ following the fuel cell system shutdown, or during the startup when H₂ gets into the anode that is already filled with air, an O₂/H₂ boundary is formed at the anode. The dotted vertical line hypothetically represents the O₂/H₂ boundary in FIG. 2, and it separates the unit cell into I, II, III, and IV parts. These four parts form an internal circuit as indicated by the arrows for the flows of the electrons and the protons in FIG. 2. The half reaction at Part I is the common hydrogen oxidation reaction (HOR) with an electrode/PEM interfacial potential of around 0 V according to Reaction (3):

H₂=2H⁺+2e⁻ E°=0.0 V (3)

The half reaction at Parts II and III is the common oxygen reduction reaction (ORR) with an electrode/PEM interfacial potential of around 1 V according to Reaction (2). Since the overall potential difference between and cathode and the anode is around 1 V, the potential difference between Part IV and Part III should be close to this potential difference, and Part III has an electrode/PEM interfacial potential of around 1 V, then the electrode/PEM interfacial potential is around 2 V at Part IV. In various tests, the potential difference between Part IV and Part III is around 1.6 V. Under such a high potential, carbon corrosion, Pt oxidation and dissolution, and water electrolysis will occur at Part IV according to Reactions (4), (5) and (6), respectively. Water electrolysis normally does not cause damages to the cathode, but carbon corrosion and Pt dissolution will quickly and significantly damage the cathode catalyst layer in Part IV.

C+2H₂O=CO₂+4H⁺+4e⁻ E°=0.2 V (4)

Pt=Pt²⁻+2e⁻ E°=1.2 V (5)

H₂O=0.5O₂+2H⁺+2e⁻ E°=1.2 V (6)

The O₂/H₂ boundary moves along the surface of the anode when a second gas (e.g., air) gets into the chamber filled with a first gas (e.g., H₂). If the second gas diffuses into the anode chamber from the environment, the movement of the boundary is quite slow, and then the time that Part IV experiences a voltage of ca. 1.6 V is long, causing more damage. If the second gas is purged into the anode that is filled with the first gas, the time will be shorter for the boundary to move over the entire anode, and therefore, the damage caused to Part IV will be much smaller. Fast purging is a common method used by various fuel cell developers to reduce the damage of an O₂/H₂ boundary to the cathode during the fuel cell shutdown and startup processes.

In order to limit the impact of OCV, people often think to use N₂ to purge the anode after a fuel cell is shut down. Actually, any inert gas can be used for such a purging purpose. However, since air from the environment will gradually diffuse into the anode during the fuel cell non-operational time period, the decay caused by the OCV is not prevented, and N₂ purging during the startup is always necessary in order to prevent an air/fuel boundary formation. Also, purging using N₂ is not convenient because a N₂ cylinder must be carried for motive and portable applications and be installed on sites for stationary applications. If N₂ is not available purging the anode with air or cathode exhaust is also helpful because it can dramatically shorten the presence time of an air/H₂ boundary at the anode.

Instead of using an inert gas to purge the anode, H₂ from either the fuel tank or the anode exhaust can also be used to purge the cathode before the fuel cell gets into the non-operational state. With H₂ presence in the anode, the formation of an O₂/H₂ boundary at the cathode will not cause any interfacial potential beyond ca. 1 V as shown by FIG. 3. If H₂ can be maintained in both the anode and the cathode during a short non-operational time period (such as less than 10 minutes), restarting the fuel cell system is not likely to result in any potential higher than about 1 V. Therefore, both the damages caused by the OCV and the O₂/H₂ boundary are avoided. Before H₂ purging a dummy or auxiliary load can be used to diminish the concentration of O₂ in the cathode. However, for a longer non-operational time period (such as longer than 30 minutes) both the anode and the cathode chambers will be filled with air because air from the environment will diffuse into the stack, and thus the problems associated with the OCV during the non-operational time period and the formation of an O₂/H₂ boundary during the next startup can not be completely avoided.

### SUMMARY OF THE PRESENT INVENTION

Despite all the recent advances in reducing the impacts of the OCV and the O₂/H₂ boundary via purging using N₂, air, or H₂, the impacts of the OCV and the O₂/H₂ boundary have not been completely resolved, because for a longer non-operational time period, air from the environment will diffuse into both the anode and the cathode chambers, potentially resulting in damage due to the formation of an air/H₂ boundary; and when both chambers are filled with air, the OCV damage will start; also, during the subsequent startup, an O₂/H₂ boundary will form again to cause further damage.

It is an object of this invention to provide methods and devices to completely avoid damages caused by the OCV and the oxidizer/fuel boundary and thus to significantly increase the durability and lifetime of a fuel cell.

It is another object of this invention to prevent H₂ losses during the fuel cell non-operational time period.

It is a further object of this invention to provide methods and devices to completely avoid damages caused by the OCV to the MEAs and stacks during their storage time period.

### BRIEF DESCRIPTION OF THE DRAWINGS

A complete understanding of the present invention may be obtained by referring to the accompanying drawings when considered in conjunction with the subsequent description.

FIG. 1 illustrates the typical OCV and the anode/electrolyte and the cathode/electrolyte interfacial potentials in the fuel cell non-operational time period when both and anode and the cathode chambers are filled with air.

FIG. 2 illustrates the voltage situation when an O₂/H₂ boundary forms at the anode during the startup of a fuel cell when H₂ enters the anode chamber that is filled with air or during the shutdown of a fuel cell when air from the environment enters the anode chamber that contains H₂.

FIG. 3 illustrates the voltage situation when an O₂/H₂ boundary forms at the cathode during the startup of a fuel cell when both the anode chamber and the cathode chamber are filled with H₂.

FIG. 4 illustrates the diffusion of H₂ and air through the electrolyte after a fuel cell gets into the non-operational state.

FIG. 5 illustrates the OCV and the anode/electrolyte and cathode/electrolyte interfacial potentials when both the anode and cathode chambers are filled with H₂.

FIG. 6 illustrates a device of this invention to enhance the lifetime of fuel cells.

FIG. 7 illustrates an open-cathode stack with covers mounted on it for transporting air.

FIG. 8 illustrates a gas-tight enclosure that has operable and sealable doors.

FIG. 9 illustrates the structure after the doors on the enclosure shown in FIG. 8 are opened for operating an open-cathode stack of this invention.

FIG. 10 illustrates a fuel cell system shutdown procedure of this invention.

FIG. 11 illustrates another fuel cell system shutdown procedure of this invention.

FIG. 12 illustrates another fuel cell system shutdown procedure of this invention.

FIG. 13 illustrates another fuel cell system shutdown procedure of this invention.

FIG. 14 illustrates another fuel cell system shutdown procedure of this invention.

FIG. 15 illustrates another fuel cell system shutdown procedure of this invention.

FIG. 16 illustrates another fuel cell system shutdown procedure of this invention.

FIG. 17 illustrates another fuel cell system shutdown procedure of this invention.

FIG. 18 illustrates a procedure of this invention to store MEAs and stacks.

FIG. 19 illustrates the quick consumption of O₂ remaining in the cathode by using an external power source.

In those figures and illustrations, the major components are labeled as follows:

1—anode; 2—cathode; 3—electrolyte; 4—initial stage; 5—middle stage; 6—final stage; 7—hydrogen source; 8—external power source; 801—gas-tight enclosure; 802—stack; 803—enclosure-H₂-inlet-solenoid valve; 804—enclosure-H₂-outlet-solenoid valve; 805—support for stack; 806—pressure regulator; 807—H₂ concentration sensor; 808—stack-H₂-inlet; 809—stack-H₂-outlet; 810—stack-coolant-inlet; 811—stack-coolant-outlet; 812—stack-air-inlet; 813—stack-air-outlet; 814—enclosure-H₂-inlet; 815—enclosure-H₂-outlet; 816—cover for open-cathode stack; 817—duct; 818—door;.

A fuel cell system may not contain all of those components or contain more components, depending on the design and control strategies of the developer.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The essence of this invention is to create a H₂ environment for the stack, and to make both its anode and cathode chambers filled with H₂ after the fuel cell system does not need to provide power to the external load.

With air as the oxidizer and H₂ as the fuel, the invention is described below in general.

The method to enhance the lifetime of fuel cells is basically as follows: After the fuel cell system does not need to provide power to the external load, that is after the fuel cell system enters either the idling or the shutdown state (altogether called the non-operational state in this invention; when the fuel cell system provides power to the external load, it is called the operational state in this invention), a H₂ environment is created for the stack, and the said H₂ environment is made of H₂ confined within a sealed enclosure, and the said sealed enclosure is made of a gas-tight material that resists H₂ embrittlement. Since the stack is within a H₂ environment air from the environment is not able to diffuse into the stack in the entire fuel cell non-operational time period, and therefore, the formation of an O₂/H₂ boundary will not occur after the fuel cell enters the non-operational state.

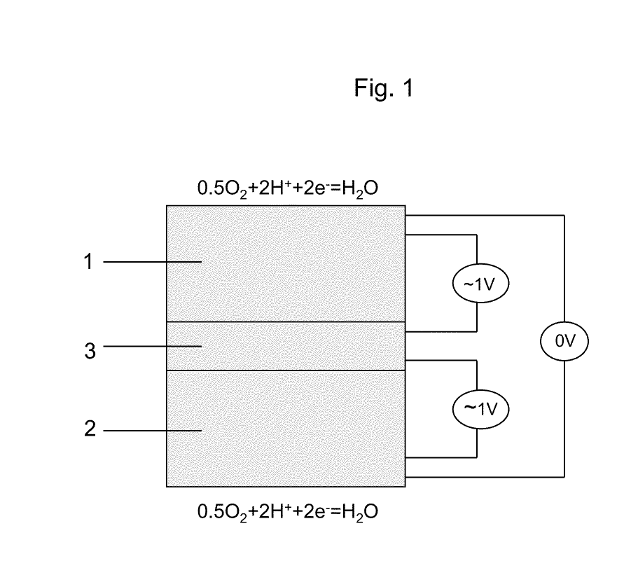

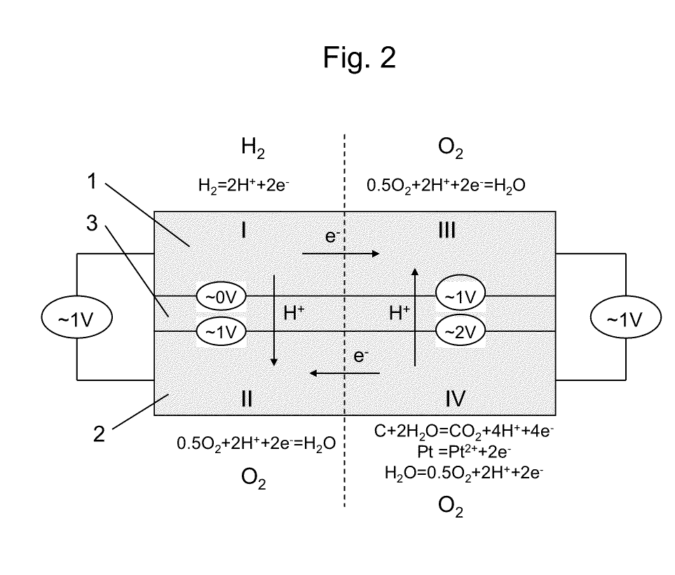

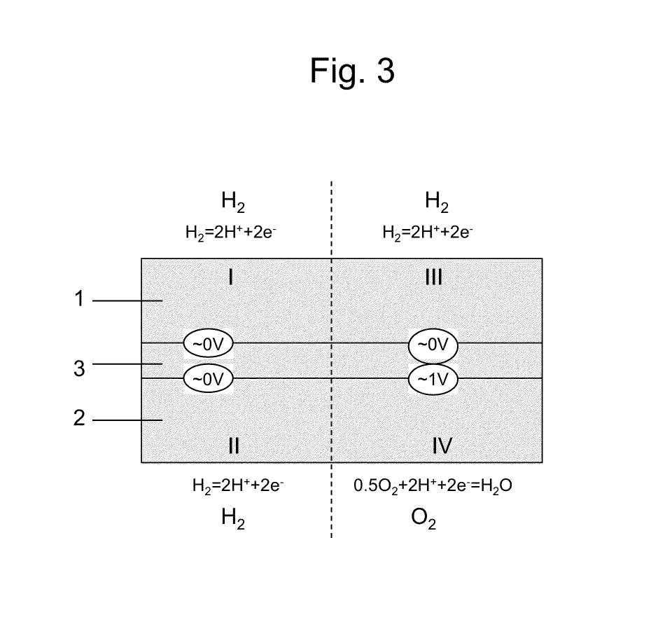

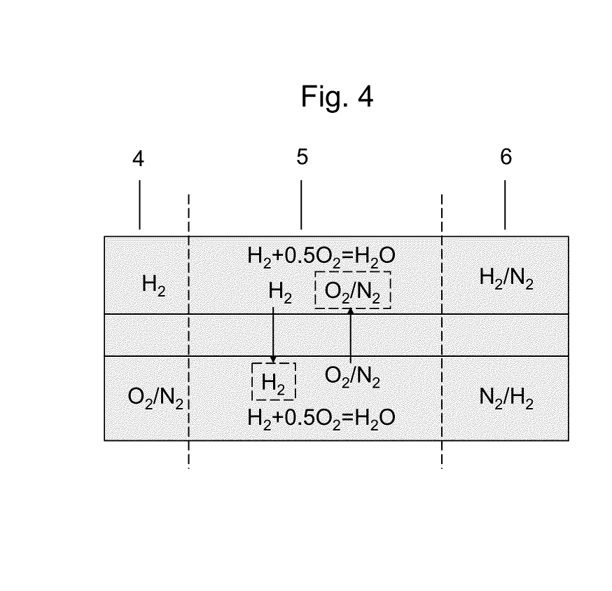

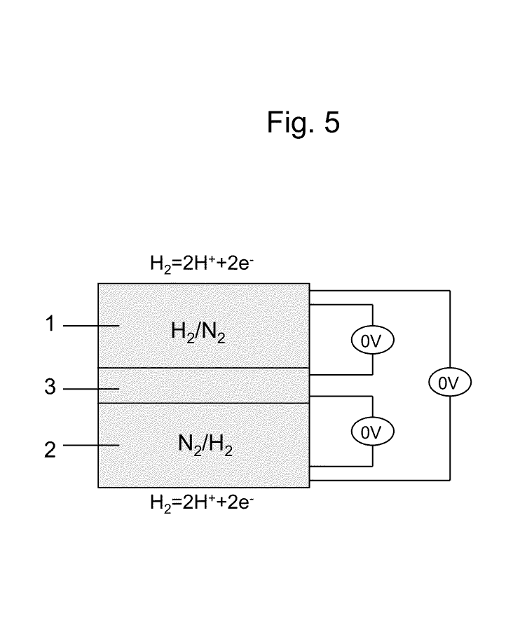

After the fuel cell enters the non-operational state, O₂ remaining in the cathode will diffuse through the electrolyte to the anode where it chemically reacts with H₂ to form water; similarly, H₂ remaining in the anode will diffuse through the electrolyte to the cathode where it chemically reacts with O₂ to form water; finally, both the anode and the cathode chambers are filled with a mixture of H₂ and N₂. The entire process is shown in FIG. 4, where the H₂ and O₂/N₂ in dotted rectangles represent gases coming from the opposite chamber. Because both of the anode and the cathode chambers are filled with H₂ (and inert gas N₂), the anode/electrolyte and the cathode/electrolyte interfacial potentials are both 0 V determined by Reaction (3) as shown in FIG. 5. Therefore, there will be no OCV damage to either the anode or the cathode, which is in distinct contrast to the situation shown in FIG. 1 where both the anode/electrolyte and the cathode/electrolyte interfacial potentials are around 1 V. When air is sent to the cathode during the next startup, O₂ will meet H₂ pre-existing in the cathode to form an O₂/H₂ boundary as shown by FIG. 3. However, since both the anode and the cathode chambers are initially filled with H₂, the formation of the said O₂/H₂ boundary only boosts the electrode/electrolyte interfacial potential in Part IV to around 1 V, which is the normal OCV, not the ˜2 V electrode/electrolyte interfacial potential in Part IV shown in FIG. 2, and thus the impact of the high electrode/electrolyte interfacial potential illustrated in FIG. 2 is avoided.

In the above method to enhance the fuel cell lifetime, the stack-air-inlet, the stack-air-outlet, the stack-H₂-inlet, and the stack-H₂-outlet can all be turned into the closed state after the fuel cell system enters the non-operational state.

In the above method to enhance the fuel cell lifetime, the stack-air-inlet, the stack-air-outlet, and the stack-H₂-outlet can all be turned into the closed state after the fuel cell system enters the non-operational state, but the stack-H₂-inlet can be kept open all the time so that H₂ can enter the stack automatically from the H₂ source when needed.

In the above method to enhance the fuel cell lifetime, the stack-air-inlet, the stack-air-outlet, and the stack-H₂-outlet can all be turned into the closed state after the fuel cell system enters the non-operational state, but the stack-H₂-inlet is kept open for 10-20 minutes so that H₂ can enter the stack automatically from the H₂ source when needed, then the stack-H₂-inlet is closed.

In the above method to enhance the fuel cell lifetime, the H₂ pressure within the gas-tight enclosure is set higher than 1 atmosphere.

In the above method to enhance the fuel cell lifetime, the O₂ remaining in the cathode chamber can be quickly purged out by H₂ after the fuel cell system does not need to provide power to the external load.

In the above method to enhance the fuel cell lifetime, the O₂ remaining in the cathode chamber can be quickly consumed by connecting the stack with a dummy or auxiliary load after the fuel cell system does not need to provide power to the external load.

In the above method to enhance the fuel cell lifetime, the O₂ remaining in the cathode chamber can be quickly consumed by pumping H₂ from the anode to the cathode through the use of a small external power source after the fuel cell system does not need to provide power to the external load, with the said power source applying about 50 mV on the anode and 0 mV on the cathode of each MEA within the stack.

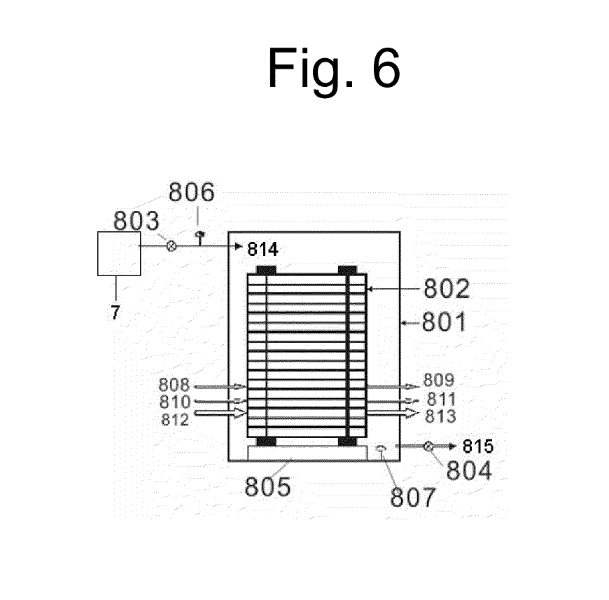

A device of this invention to carry out the methods described above is illustrated in FIG. 6. It consists of a H₂-filled gas-tight enclosure 801 within which the stack 802 is placed. There is an enclosure-H₂-inlet 814 and an enclosure-H₂-outlet 815 on the enclosure 801 to connect between the inside of the enclosure 801 and the outside of the enclosure 801. There are openings (not shown in FIG. 6) on the enclosure 801 that enable pipelines that are connected to the stack to pass through; the pipelines include the stack-H₂-inlet pipeline, the stack-H₂-outlet pipeline, the stack-air-inlet pipeline, the stack-air-outlet pipeline, the stack-coolant-inlet pipeline, and the stack-coolant-outlet pipeline.

In the above device to enhance the lifetime of fuel cells, there is a pipeline connecting the H₂ source 7 to the enclosure 801 through the enclosure-H₂-inlet 814, and there is a pipeline that connects the enclosure 801 with the outside environment through enclosure-H₂-outlet 815.

In the above device to enhance the lifetime of fuel cells, there is an enclosure-H₂-inlet-solenoid valve 803 on the pipeline connecting the H₂ source 7 to the enclosure 801, and there is an enclosure-H₂-outlet-solenoid valve 804 on the pipeline that connects the enclosure 801 with the outside environment.

The enclosure-H₂-inlet-solenoid valve 803 on the pipeline is used to open or close the connection between the H₂ source 7 and the enclosure 801. The pressure regulator 806 on the pipeline is used to control the pressure of H₂ entering and filling the gas-tight enclosure 801, and the pressure of H₂ within the enclosure 801 equals to that preset by the pressure regulator 806. If the enclosure 801 contains unacceptable amount of air, both the enclosure-H₂-inlet-solenoid valve 803 and the enclosure-H₂-outlet-solenoid valve 804 are opened to purge air out with H₂, and then the enclosure-H₂-outlet-solenoid valve 804 is closed.

In the above device to enhance the lifetime of fuel cells, there can be a H₂ concentration sensor 807 placed within the enclosure 801 to monitor the concentration of H₂ within the enclosure 801.

In the above device to enhance the lifetime of fuel cells, there can be a gas pressure sensor (not shown in FIG. 6) placed within the enclosure 801 to monitor the total gas pressure within the enclosure 801. It is adequate as long as the H₂ pressure within the enclosure 801 is greater than 1 atmosphere, such as 1.05 bara. Because the pressure difference between H₂ inside the enclosure 801 and air in the environment is very small, the thickness of the enclosure wall can be quite thin.

In the above device to enhance the lifetime of fuel cells, the wall thickness of enclosure 801 can be around 1-3 mm.

In the above device to enhance the lifetime of fuel cells, the enclosure 801 is made of materials such as aluminum or its alloys, stainless steel, or dense polyethylene, which are impermeable to H₂ and have good property against H₂ embrittlement. These are common materials that are used to make H₂ storage cylinders.

In the above device to enhance the lifetime of fuel cells, an insulating material (not shown in FIG. 6) can be used to wrap around the outer or the inner surface of the enclosure 801 to thermally insulate the stack from the environment. This will help the cold start of the stack 802, especially when the environment temperature is low in winters.

In the above device to enhance the lifetime of fuel cells, a desiccant (not shown in FIG. 6) can be placed within the enclosure 801 to adsorb water and its moisture.

In the above device to enhance the lifetime of fuel cells, the stack 802 is placed on a support 805 to prevent any extruding portions of the stack 802 to damage the enclosure 801.

In the above device to enhance the lifetime of fuel cells, the gaps between the openings (not shown in FIG. 6) on the enclosure for allowing the pipelines to transport hydrogen, air, and coolant to pass through and those pipelines are completed sealed.

In the above device to enhance the lifetime of fuel cells, the enclosure 801 is large enough as long as the stack 802 can be placed inside.

In the above device to enhance the lifetime of fuel cells, the enclosure 801 can have an operable and sealable door for the placement or removal of components in or from the enclosure 801.

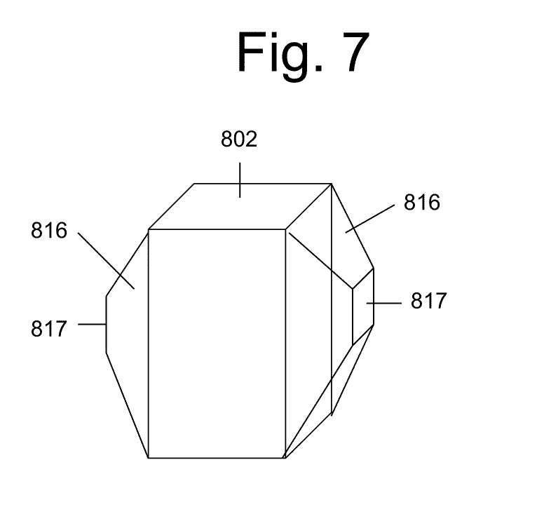

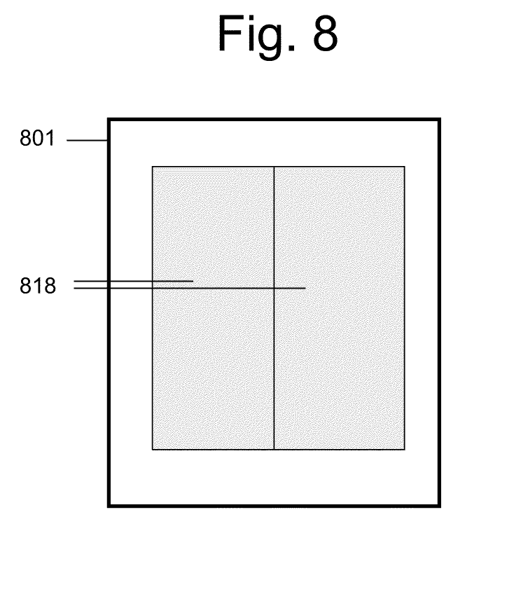

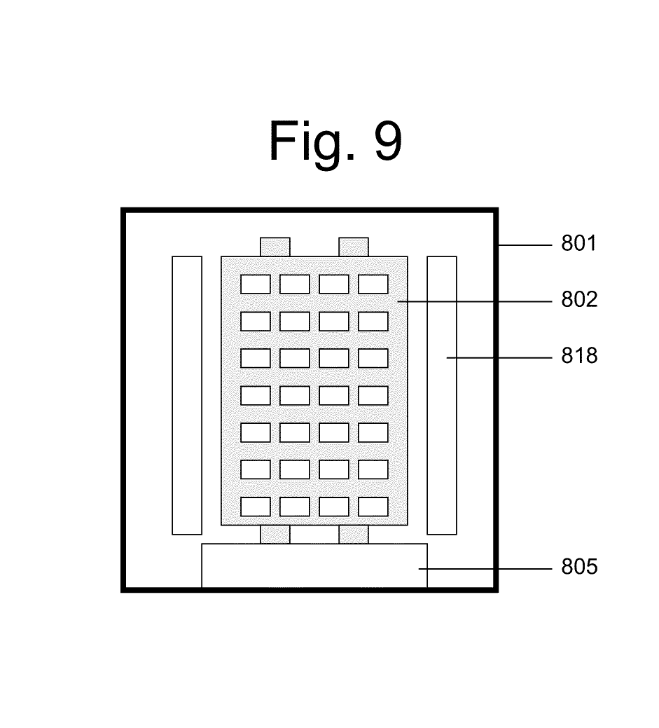

The stack 802 illustrated in FIG. 6 is a closed-cathode stack; that is a stack whose cathode channels are not exposed to the environment. The above device to enhance the lifetime of fuel cells is also suitable for an open-cathode stack; that is a stack whose cathode channels open to the environment. One option is to cover the stack-air-inlet and the stack-air-outlet sides fully with covers 816 that have narrower ducts 817, as shown in FIG. 7. The two covers are mounted on the opposite sides of the stack and face the open-cathode channels. One cover collects air from the environment and sends it into the stack, and the other cover sends the cathode exhaust out into the environment, so that air can pass through every open cathode channel evenly. The ducts 817 are properly sized so that they can be connected with the stack-air-inlet and the stack-air-outlet pipelines. Another option for handling an open-cathode stack is to make two operable and sealable doors 818 on enclosure 801 to face the stack air flow channels as shown in FIGS. 8 and 9; these two doors are opened during the operation of the fuel cell stack (FIG. 9) and are closed in the non-operational time period (FIG. 8).

The above method can also be used for MEAs and stacks during their storage time period. After they are made but before integrated into a fuel cell system, they are stored in a man-made H₂ environment instead of the common air environment, and the said H₂ environment is confined within a gas-tight enclosure.

A device to store MEAs and stacks consists of a H₂-filled gas-tight enclosure; there is a pipeline connecting the H₂ source to the enclosure and there is a pipeline that connects the enclosure with the outside environment; there is a solenoid valve on the pipeline connecting the H₂ source to the enclosure, and a solenoid valve on the pipeline that connects the enclosure with the outside environment; there is a pressure regulator on the pipeline connecting the H₂ source to the enclosure to control the pressure of H₂ entering and filling the enclosure; there is a H₂ concentration sensor placed within the enclosure to monitor the concentration of H₂ within the enclosure; there is a gas pressure sensor to monitor the gas pressure within the enclosure; and there is an operable and sealable door on the enclosure for the placement or removal of components into or from the enclosure.

Because the enclosure 801 is completely gas-tight, once it is filled with H₂ it will keep it. Thus, there is little H₂ loss from the enclosure to the environment.

The benefits of the invented method and device include the followings: Since a man-made H₂ environment is created for the stack, air from the environment will not be able to enter the stack, and both the anode and the cathode chambers will be filled with H₂, and thus the impacts of OCV and the formation of an O₂/H₂ are eliminated completely. Since the MEAs and stacks are stored in a H₂ environment, the impact of the OCV is completely eliminated during their storage time period.

There are several methods to fill both the anode chamber and the cathode chamber of the stack with H₂ after the fuel cell system enters the non-operational state. The simplest method relies on nature diffusion of H₂ and air through the electrolyte such as the proton exchange membrane (PEM) in a PEM fuel cell to the opposite chamber as illustrated in FIG. 4. In the initial stage the anode and the cathode chambers have remaining H₂ and air, respectively. In the middle stages some H₂ diffuses to the cathode and some air diffuses to the anode; H₂ and O₂/N₂ in the dotted rectangles mean that they come from the opposite chamber. H₂ and O₂ will chemically react in both chambers once they meet according to Reaction (1). Finally, both chambers are filled with a mixture of H₂ and N₂ because all of the O₂ originally present in cathode chamber is consumed. There may be a time period that the absolute gas pressure within both the anode chamber and the cathode chamber drops to below the atmosphere pressure, and some H₂ within the enclosure 801 will diffuse into the chamber. Finally, the absolute pressure of both chambers will be equal to the H₂ pressure within the enclosure. Another method is to purge the air within the cathode chamber out with H₂ after the fuel cell system stops providing power to the external load. A third method is to use a dummy or auxiliary load to quickly consume the O₂ within the cathode chamber. A forth method is to pump the H₂ from the anode to the cathode by using a small external power source.

In the above method relying on natural gas diffusion the stack-H₂-inlet can be kept open to facilitate the diffusion of H₂ through the electrolyte and thus the O₂ consumption in the cathode chamber.

Since the stack is within the H₂-filled enclosure, both the anode chamber and the cathode chamber will maintain the H₂-filled state in the entire fuel cell non-operational time period no matter how long it is.

As illustrated by FIG. 5, the cell OCV and the anode/electrolyte and cathode/electrolyte interfacial potentials of each unit cell within the stack are all 0 V when both the anode chamber and the cathode chamber of the stack are filled with H₂. Therefore, damage caused by the OCV is completely avoided in the entire non-operational time period, no matter how long it is.

Under such a condition, when air gets into the cathode chamber during the subsequent startup process of the fuel cell, an O₂/H₂ boundary does form at the cathode; but since the anode is filled with H₂ already, the OCV and the anode/electrolyte and cathode/electrolyte interfacial potentials of each unit cell within the stack can only get as high as 1 V. The voltage situation is the same as that illustrated in FIG. 3. Therefore, the formation of such an O₂/H₂ boundary does not cause any damage to either the anode or the cathode.

For a fuel cell system using an open-cathode stack covers can be made on the stack as illustrated in FIG. 7.

Doors that can open and close can also be made on two opposite sides of the gas-tight enclosure to manage the air to pass through an open-cathode stack as illustrated in FIGS. 8 and 9. In the fuel cell operational state these operable and sealable doors are opened as shown in FIG. 9 to allow air to evenly pass through each open cathode channel. One mechanism to open the doors is to allow the doors to slide towards the edges to fully expose the open cathode channels of the stack to the environment. In the fuel cell non-operational state these operable and sealable doors are closed and sealed, and the enclosure achieves gas-tight as shown in FIG. 8 to isolate the stack from the environment. Then, air in the enclosure is replaced by H₂. In the subsequent startup process, the operable and sealable doors are opened to first let H₂ out and then air is sent into the stack through the open cathode channels.

When a fuel cell system whose stack is exposed to a H₂ environment during a previous non-operational time period is restarted, the H₂ environment can be remained for a closed-cathode stack. In other word, a closed-cathode stack can be within a H₂ environment in both the operational and the non-operational time periods, and thus the enclosure requires very little H₂ to refill in the entire lifetime of the fuel cell system. For an open-cathode stack the H₂ within the enclosure is replaced by air before the fuel cell system restarts; and after the fuel cell system enters the non-operational state, the air in the enclosure is replaced by H₂, preferentially after the voltage of the stack drops to nearly 0 V.

The invention is further described in detailed with the aid of figures and examples.

### Method to Enhance Fuel Cell Lifetime

A H₂ environment is created for the stack, and the said H₂ environment is made of H₂ confined within a sealed enclosure, and the said sealed enclosure is gas-tight and made of a material that resists the H₂ embrittlement. Since the stack is within a H₂ environment air from the environment is not able to diffuse into the stack in the entire fuel cell non-operational time period to assure that both the anode and the cathode chambers are filled with H₂, and therefore, to avoid the anode/electrolyte and the cathode/electrolyte interfacial potentials to be around 1 V in the entire fuel cell non-operational state, and to avoid damage due to the formation of an O₂/H₂ boundary during the fuel cell shutdown and startup processes.

The procedure is as follows: After the fuel cell enters the non-operational state, the stack-air-inlet 812, the stack-air-outlet 813, and the stack-H₂-outlet 809 are closed, but the enclosure-H₂-inlet is in the open state to make the stack in a H₂ environment. This H₂ environment for the stack can be created during the first time the fuel cell system is operated and maintained throughout the lifetime of the fuel cell system for closed-cathode stack. H₂ remaining in the anode chamber and O₂ remaining in the cathode chamber will diffuse through electrolyte 3 to the opposite chamber, where they chemically react to form H₂O, therefore, both chambers will be finally filled with a mixture of H₂ and N₂. The stack-H₂-inlet 808 can be closed at the moment the fuel cell system enters the non-operational state; it can also be kept open for 10-20 minutes after the fuel cell system enters the non-operational state, then it is closed; it can also be kept open for all the time. When the stack-H₂-inlet is in the open state, H₂ will be able to enter the stack 802 through the stack-H₂-inlet 808; this will facilitate the diffusion of H₂ through electrolyte 3. In this process, the H₂ pressure within the gas-tight enclosure 801 is kept higher than 1 atmosphere, such as at 1.1 atmospheres.

A short time after the fuel cell system enters the non-operational state the O₂ within the cathode chamber will be completely consumed by H₂ coming from the anode chamber via diffusion through the electrolyte 3, and thus the cathode chamber is finally filled with a mixture of H₂ and N₂, but N₂ is the major component. Similarly, air diffuses from the cathode to the anode through the electrolyte 3; O₂ chemically reacts with H₂ in the anode chamber, but N₂ does not participate in the reaction; therefore, the anode chamber is also filled with a mixture of H₂ and N₂, but with H₂ as the major component.

The entire process is shown in FIG. 4, where the H₂ or O₂/N₂ in dotted rectangles represents gases coming from the opposite chamber. Because both of the anode and the cathode chambers are filled with H₂ (and inert gas N₂), the anode/electrolyte and the cathode/electrolyte interfacial potentials are both 0 V determined by Reaction (3) as shown in FIG. 5. Therefore, there will be no OCV damage to either the anode or the cathode, which is in distinct contrast to the situation shown in FIG. 1 where both the anode/electrolyte and the cathode/electrolyte interfacial potentials are around 1 V. When air is sent to the cathode during the next startup, O₂ will meet H₂ pre-existing in the cathode to form an O₂/H₂ boundary as shown by FIG. 3. However, since both the anode and the cathode chambers are initially filled with H₂, the formation of the said O₂/H₂ boundary only boosts the electrode/electrolyte interfacial potential in Part IV to around 1 V as shown in FIG. 3, the normal OCV, not the ˜2 V electrode/electrolyte interfacial potential in Part IV illustrated in FIG. 2, and thus the impact of the high electrode/electrolyte interfacial potential shown in FIG. 2 is avoided.

In the above method, the O₂ remaining in the cathode chamber can be quickly purged out by H₂ after the fuel cell system enters the non-operational state.

In the above method, when the stack-H₂-inlet 808 is in the opened state, the O₂ remaining in the cathode chamber of stack 802 can be quickly consumed by connecting the stack 802 with a dummy or auxiliary load after the fuel cell system enters the non-operational state. The said dummy or auxiliary load refers to a suitably small load that is not the load the fuel cell system provides power for; the dummy or auxiliary load can be a resistor, or a parasitic power consumption device of the fuel cell system such as the control boards or small fans.

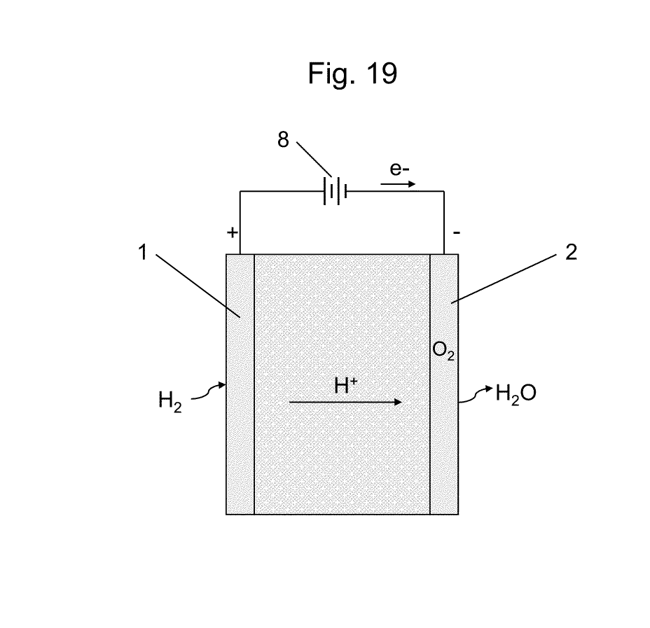

In the above method, when the stack-H₂-inlet 808 is in the opened state, the O₂ remaining in the cathode chamber of stack 802 can be quickly consumed by pumping H₂ from the anode to the cathode through the use of a small external power source 8 that applies about 50 mV voltage on each anode 1 of the stack 802 and about 0 mV voltage on each cathode 2 of each MEA within the stack 802 (FIG. 19).

In the above procedure the enclosure-H₂-inlet 814 is preferentially in the open state for all the time. If the enclosure-H₂-inlet 814 is not in the open state after the fuel cell system stops providing power to the external load, it can be opened. The opening of the enclosure-H₂-inlet-solenoid valve 803 can be done immediately after the fuel cell stops providing power to the external load, or after the stack OCV drops to nearly 0 V through either natural diffusion of H₂ and O₂ through the electrolyte, or purging of the cathode chamber with H₂, or using a dummy or auxiliary load, or by applying an external power source to consume the O₂ in the cathode chamber.

### Device to Enhance Lifetime of Fuel Cells

A device to carry out the invented method is illustrated in FIG. 6. It consists of a H₂-filled gas-tight enclosure 801 within which the stack 802 is placed. There is an enclosure-H₂-inlet 814 and an enclosure-H₂-outlet 815 on the enclosure 801 for adjusting the H₂ concentration of the H₂ environment within the enclosure 801. There is an enclosure-H₂-inlet-solenoid valve 803 and an enclosure-H₂-outlet-solenoid valve 804 respectively to control H₂ getting in or out of the enclosure 801. There are some properly sized openings (not shown in FIG. 6) on the enclosure 801 to allow the pipelines connected to the stack 802 to pass through; the gaps between the pipelines and the openings are sealed to prevent leakage of H₂; said pipelines may include H₂ pipelines connected to the stack 802 through the stack-H₂-inlet 808 and the stack-H₂-outlet 809, the air pipelines connected to the stack 802 through the stack-air-inlet 812 and the stack-air-outlet 813, and the coolant pipelines connected to the sack 802 through the stack-coolant-inlet 810 and the stack-coolant-outlet 811. With the above configuration the stack 802 is located in the gas-tight enclosure 801 whose inside is filled with H₂ to assure that both the anode and the cathode chambers of the stack 802 are filled with H₂ in the fuel cell non-operational time period. There is a pressure regulator 806 placed before the enclosure-H₂-inlet 814; when the H₂ pressure within the enclosure 801 becomes equal to that set by the pressure regulator 806, H₂ will stop entering the enclosure 801; if the gas pressure within the enclosure 801 drops H₂ will automatically enter the enclosure 801. There is a support 805 within the enclosure to physically support the stack 802 to prevent any extruding portions of the stack 802 from causing any damage to the enclosure 801. There is a H₂ concentration sensor 807 within the enclosure 801 to monitor the H₂ concentration. There is a gas pressure sensor (not shown in FIG. 6) to monitor the total gas pressure within the enclosure 801. There is an insulating material (not shown in FIG. 6) to wrap around either the outer or the inner surface of the enclosure 801 to aid the cold startup of the stack, especially in winters. The enclosure 801 is made of materials such as aluminum or its alloys, stainless steel, or dense polyethylene, which are impermeable to H₂ and have good property against the H₂ embrittlement. The wall thickness of the enclosure is around 1-3 mm. There is a desiccant (not shown in FIG. 6) that adsorbs water and its moisture within the enclosure 801 to keep the stack 802 in a dry environment to prevent water from condensing on the stack 802. For an open-cathode stack there are covers 816 mounted on the stack 802 as shown in FIG. 7, with their wider side covering the air channels of the stack 802, and their narrower ducts 817 connecting with the stack-air-inlet pipeline and the stack-air-outlet pipeline. An open-cathode stack refers to a stack whose air channels open to the environment. With the use of covers 816 and ducts 817, an open-cathode stack is protected similarly as a closed-cathode stack discussed in the above.

As shown in FIGS. 8 and 9 there may be operable and sealable doors 818 that can be opened and closed as needed on the enclosure 801. When an open-cathode stack is used, there are two doors 818 located in positions facing the two ends of the stack air channels. When the doors 818 are in the closed state the entire enclosure 801 is gas-tight. There are two major functions of doors 818; one function is for placing components such as stacks into and removing them from the enclosure 801; the other function is for an open-cathode stack to receive air from the environment during the operation of the fuel cell system. There are numerous ways to open the doors 818. One method is to allow the doors slide towards the edges as shown in FIG. 9. When the fuel cell system enters the non-operational state the doors 818 are closed to isolate the stack 802 from the environment and make the enclosure 801 in a H₂-filled gas-tight state, as illustrated in FIG. 8.

### Procedures to Enhance Lifetime of Fuel Cells

The followings are some procedures as examples to further illustrate the invention. It is clear that the invention is not limited to those examples.

### EXAMPLE 1

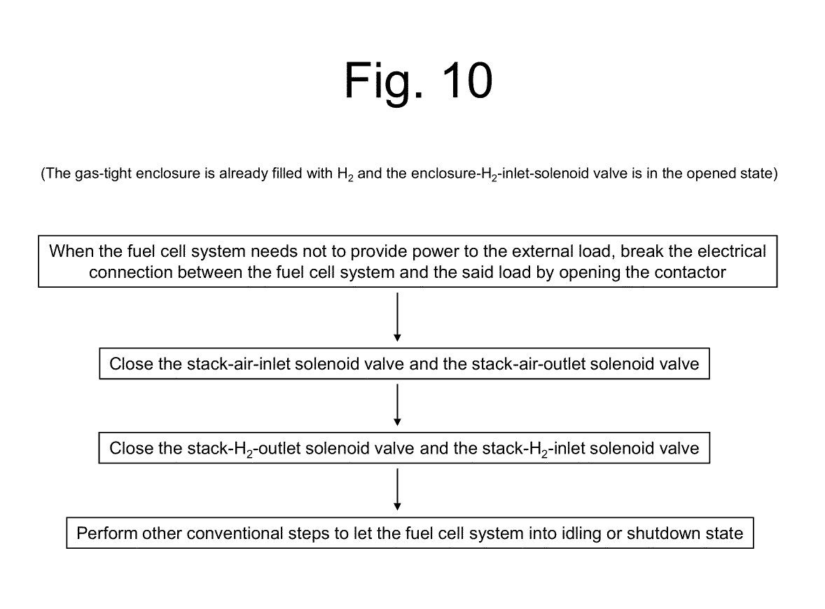

FIG. 10 illustrates a shutdown procedure when the gas-tight enclosure is already filled with H₂ and the enclosure-H₂-inlet-solenoid valve is in the opened state. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet solenoid valve and the stack-H₂-inlet solenoid valve; and perform other conventional steps to let the fuel cell system into either idling or shutdown state.

In this example, the enclosure-H₂-inlet-solenoid valve keeps open in the entire time period while the fuel cell system is in either operational or non-operational state. Because the enclose 801 is gas-tight, H₂ concentration within the enclosure changes little in the entire process. In case that the enclosure 801 does not achieve complete gas-tight due to design flaws, H₂ will keep entering the enclosure gradually to maintain the H₂ pressure within the enclose equal to that preset by the pressure regulator 806.

Because of the diffusion of H₂ and air through the electrolyte 3, and the amount of H₂ remaining in the anode chamber of the stack 802 being more than the amount of O₂ remaining in the cathode chamber of the stack 802, both the anode chamber and the cathode chamber will be finally filled with a mixture of H₂ and N₂, as illustrated by FIG. 4. In a certain stage of this process the total gas pressure within either the anode chamber or the cathode chamber will drop below the H₂ pressure within the enclosure 801, and thus some H₂ within the enclosure 801 will diffuse into both the anode and the cathode chambers, and the final gas pressure within either chamber becomes equal to the H₂ pressure within the enclosure 801. Afterwards, because the enclosure is gas-tight there will be no more H₂ getting into the enclosure 801, resulting in no H₂ loss. That the enclosure-H₂-inlet-solenoid valve 803 is kept open all the time is to assure that the enclosure 801 is always filled with H₂ and its pressure equals to that set by the pressure regulator 806. The pressure set by the pressure regulator 806 only needs to be slightly higher than the atmosphere pressure, such as at 1.05 atmospheres to completely prevent air from the environment from diffusing into the enclosure 801, even in case that the enclosure 801 does not achieve complete gas-tight due to design flaws.

### EXAMPLE 2

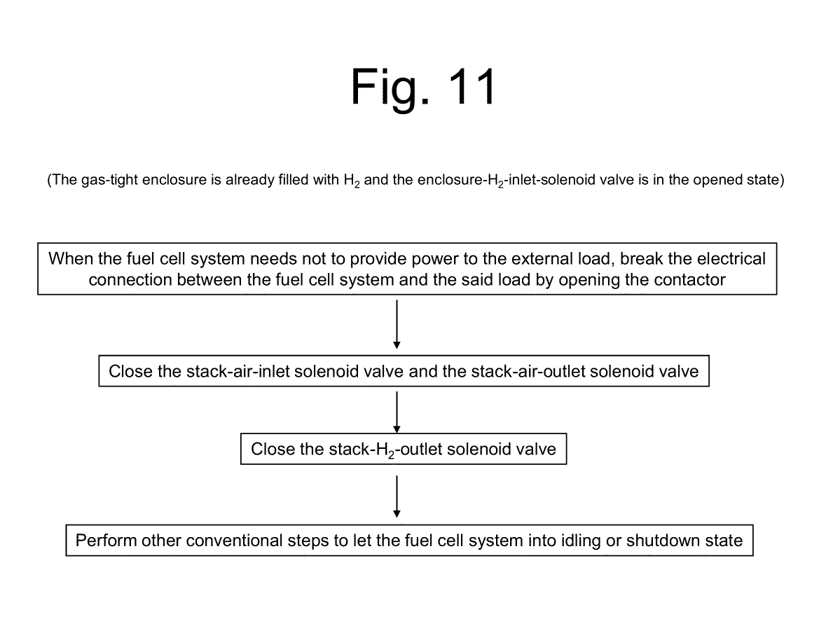

FIG. 11 illustrates another shutdown procedure when the gas-tight enclosure is already filled with H₂ and the enclosure-H₂-inlet-solenoid valve is in the opened state. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet solenoid valve; and perform other conventional steps to let the fuel cell system into the non-operational state.

In the third step of this procedure only the stack-H₂-outlet solenoid valve is closed. In other word, the stack-H₂-inlet solenoid valve is not closed. Such an arrangement can assure that the anode chamber of the stack 802 is always filled with H₂, and facilitate the diffusion of H₂ from the anode to the cathode, and thus the oxygen in the cathode can be consumed faster by H₂ diffusing through the electrolyte 3.

### EXAMPLE 3

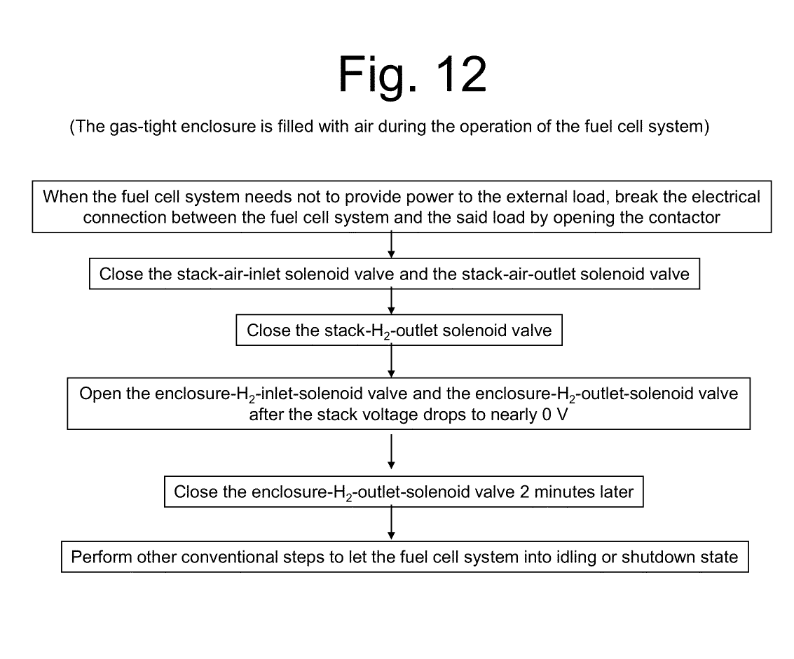

FIG. 12 illustrates a shutdown procedure when the gas-tight enclosure is filled with air during the operation of the fuel cell system. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet solenoid valve; open the enclosure-H₂-inlet solenoid valve 803 and the enclosure-H₂-outlet solenoid valve 804 after the stack voltage drops to nearly 0 V; close the enclosure-H₂-outlet-solenoid valve 804 two minutes later; and perform other conventional steps to let the fuel cell system into the non-operational state.

In this example, the enclosure-H₂-inlet-solenoid valve 803 and enclosure-H₂-outlet-solenoid valve 804 are opened after the stack voltage drops to nearly 0 V; and enclosure-H₂-outlet-solenoid valve is closed after the enclosure is filled with H₂ in 2 minutes, but the enclosure-H₂-inlet-solenoid valve is kept in the opened state afterwards.

### EXAMPLE 4

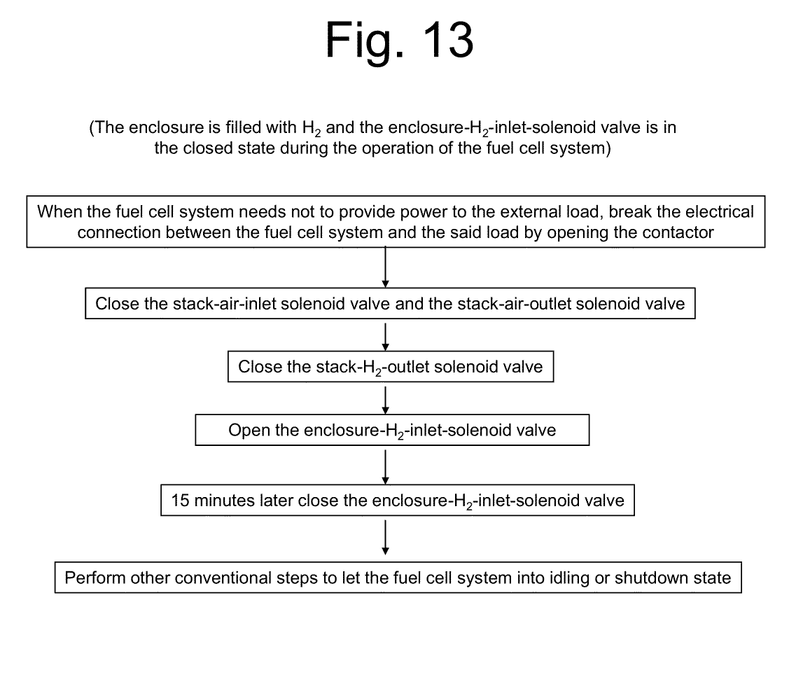

FIG. 13 illustrates a shutdown procedure when the enclosure is filled with H₂ and the enclosure-H₂-solenoid valve is in the closed state during the operation of the fuel cell system. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet solenoid valve; open the enclosure-H₂-inlet-solenoid valve 803; 15 minutes later close the enclosure-H₂-inlet-solenoid valve 803; and perform other conventional steps to let the fuel cell system into the non-operational state.

The O₂ that initially remains in the cathode chamber after the fuel cell enters the non-operational state can be fully consumed by chemically reacting with H₂ coming from the anode chamber via diffusing through the electrolyte in about 10-20 minutes (this time depends on the thickness of the electrolyte; some measurement showed about 15 minutes for a PEM with a thickness of less than 50 μm). Therefore, there is no need to keep the enclosure-H₂-inlet-solenoid valve in the opened state after about 15 minutes if the enclosure is completely gas-tight. In this procedure, the enclosure-H₂-outlet-solenoid valve is kept in the closed state.

### EXAMPLE 5

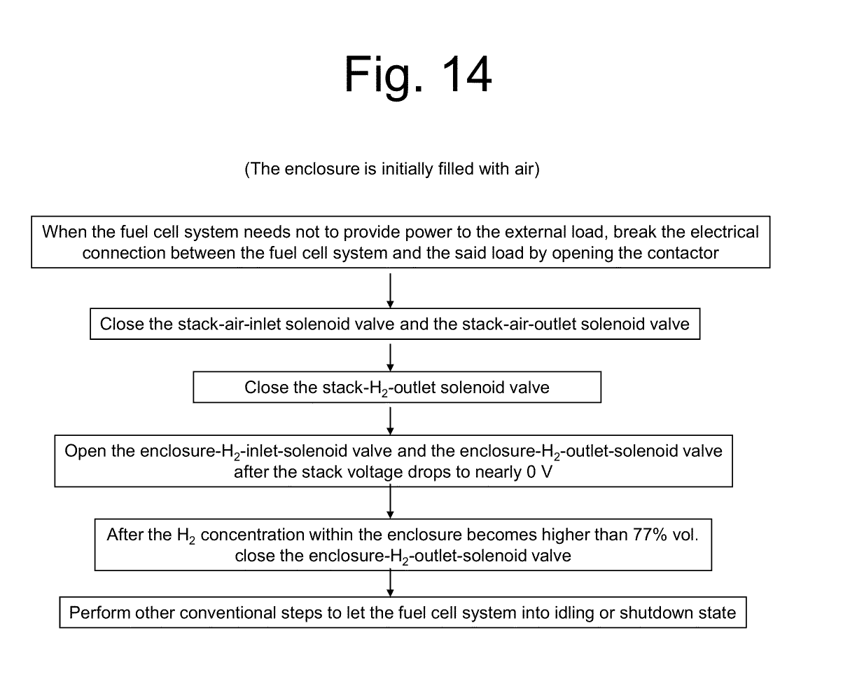

FIG. 14 illustrates a procedure when the enclosure is initially filled with air. For example, when a fuel cell system is started for the first time the enclosure is likely to be filled with air, and after the fuel cell system stop providing power to the external load, the enclosure will still be filled with air. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet solenoid valve; open the enclosure-H₂-inlet-solenoid valve 803 and the enclosure-H₂-outlet-solenoid valve 804 after the stack voltage drops to nearly 0 V; close the enclosure-H₂-outlet-solenoid valve 804 when the H₂ concentration within the enclosure becomes higher than 77%; and perform other conventional steps to let the fuel cell system into non-operational state.

Since the combustion limits of H₂ in air is 4-77% vol., a mixture of H₂ and air will not be able to combust when the H₂ concentration is greater than 77%. The enclosure-H₂-inlet-solenoid valve and the stack-H₂-inlet solenoid valve are both kept open to assure that the H₂ volumetric concentration in the enclosure 801 is always higher than 77% in the entire non-operational time period.

### EXAMPLE 6

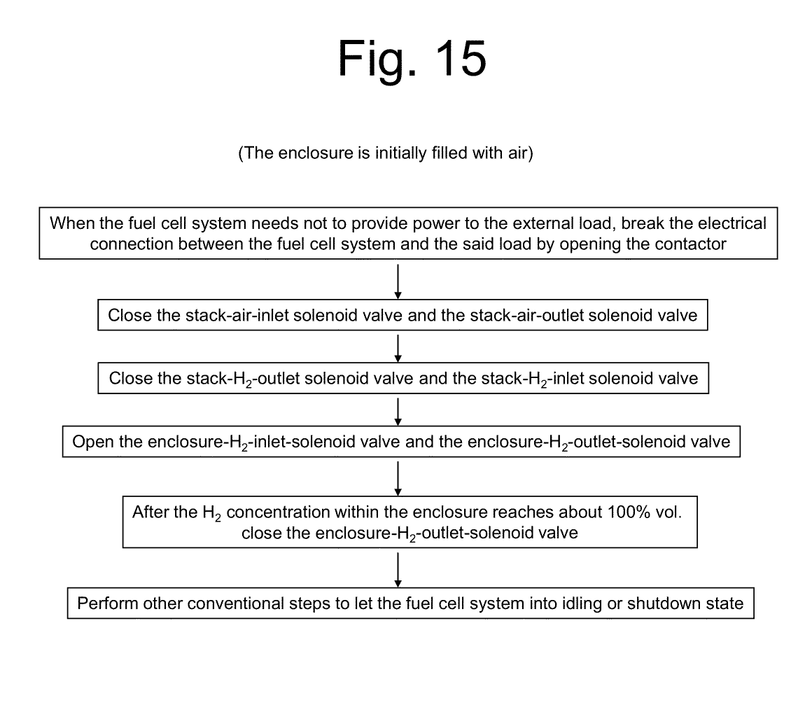

FIG. 15 illustrates another procedure when the enclosure is initially filled with air. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet-solenoid valve and the stack-H₂-inlet-solenoid valve; open the enclosure-H₂-inlet-solenoid valve 803 and the enclosure-H₂-outlet-solenoid valve 804; close the enclosure-H₂-outlet-solenoid valve 804 when the H₂ concentration within the enclosure reaches ˜100%; and perform other conventional steps to let the fuel cell system into non-operational state.

With a 100% vol. H₂ in the enclosure, it assures that no O₂ diffuses into the stack, and thus it avoids the formation of an air/fuel boundary within the stack, effectively eliminates the impact of OCV in the entire non-operational time period and the formation of air/H₂ boundary.

### EXAMPLE 7

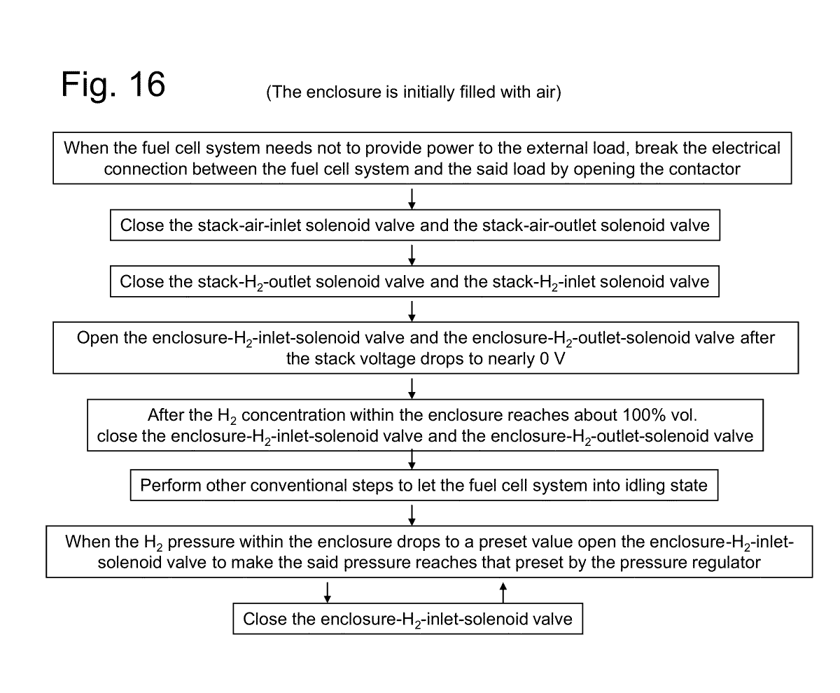

FIG. 16 illustrates a further procedure when the enclosure is initially filled with air. When the fuel cell system needs not to provide power to the external load, break the electrical connection between the fuel cell system and the said load by opening the contactor or other connection device; close the stack-air-inlet solenoid valve and the stack-air-outlet solenoid valve; close the stack-H₂-outlet solenoid valve and the stack-H₂-inlet solenoid valve; open the enclosure-H₂-inlet-solenoid valve 803 and the enclosure-H₂-outlet-solenoid valve 804 after the stack voltage drops to nearly 0 V; close the enclosure-H₂-outlet-solenoid valve 804 and enclosure-H₂-inlet-solenoid valve 803 when the H₂ concentration within the enclosure reaches ˜100%; perform other conventional steps to let the fuel cell system into idling state; open the enclosure-H₂-inlet-solenoid if the H₂ pressure within the enclosure 801 drops to a preset value to make the said pressure reaches that preset by the pressure regulator 806; close the enclosure-H₂-inlet-solenoid valve 803; the said last two steps repeat.

In this procedure the preset pressure needs to be slightly higher than 1 atmosphere, such as at 1.01 atmospheres. Through the repeating of the last two steps it assures the H₂ pressure within the enclosure, and therefore, O₂ from the environment will not be able to enter the enclosure 801, which prevents O₂ from entering the stack, effectively eliminates the impact of OCV and the formation of an air/H₂ boundary. In order to be able to perform the last two steps automatically, the fuel cell system is in the idling state not in the shutdown state.

### EXAMPLE 8

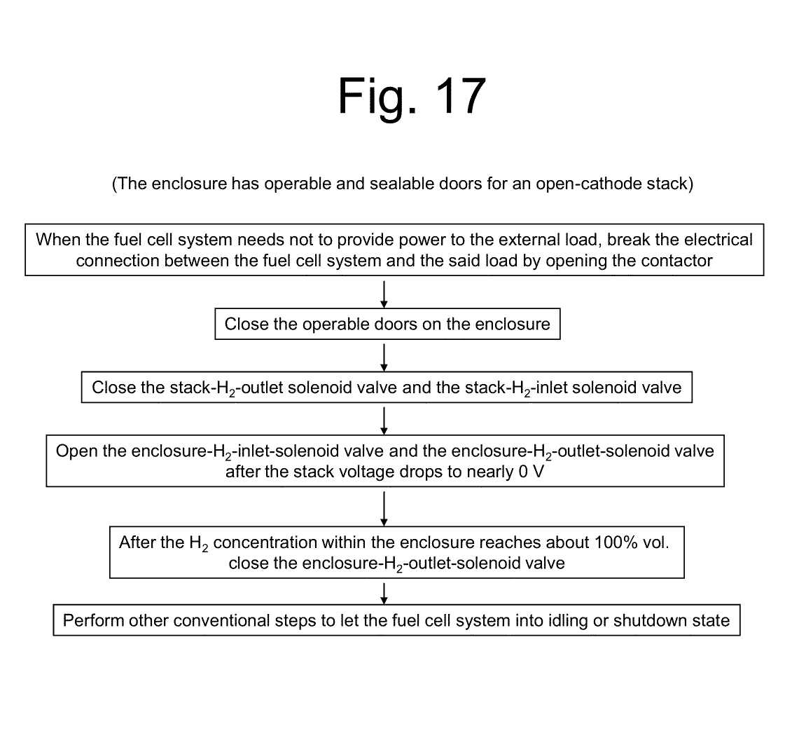

The procedure shown in FIG. 17 is applicable to a situation that the enclosure 801 has operable and sealable doors 818 when an open-cathode stack is used (refer to FIGS. 8 and 9). When the fuel cell system needs not to provide power to the external load, break the electrical connection between the fuel cell system and the said load by opening the contactor or other connection device; close the doors 818 on enclosure 801; close the stack-H₂-outlet solenoid valve and the stack-H₂-inlet solenoid valve; open the enclosure-H₂-inlet-solenoid valve 803 and the enclosure-H₂-outlet-solenoid valve 804 after the stack voltage drops to nearly 0 V; close enclosure-H₂-outlet-solenoid valve 804 when the H₂ concentration within the enclosure reaches ˜100%; and perform other conventional steps to let the fuel cell system into the non-operational state.

### EXAMPLE 9

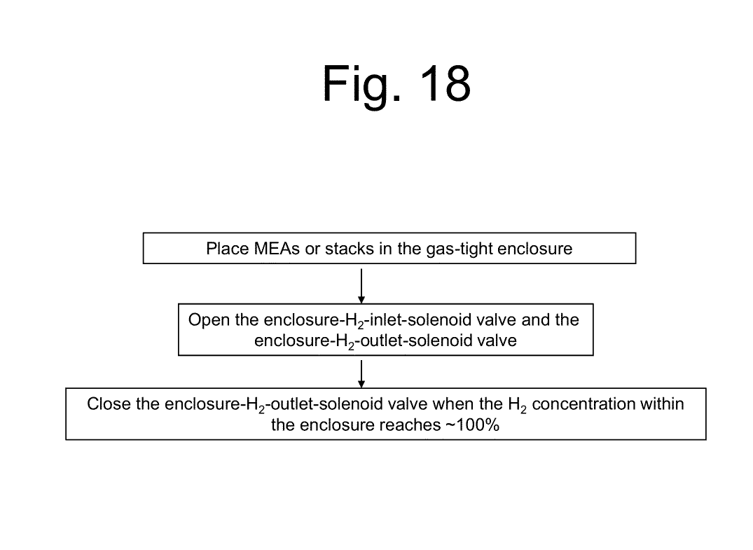

The procedure shown in FIG. 18 is applicable for storing MEAs and stacks before they are integrated into a fuel cell system. Place MEAs or stacks in a gas-tight enclosure; open the enclosure-H₂-inlet-solenoid valve and the enclosure-H₂-outlet-solenoid valve; close the enclosure-H₂-outlet-solenoid valve when the H₂ concentration within the enclosure reaches ˜100%.

In the above Examples 2, 3 and 4, since the stack-H₂-inlet solenoid valve is kept in the opened state, the O₂ remaining in the cathode chamber can be quickly consumed by using a dummy or auxiliary load, and the entire process only needs about 1 minute, depending on the power consumption rate of the dummy or auxiliary load and the volume of the cathode chamber. Disconnect the dummy or auxiliary load from the stack when the stack voltage drops to near 0 V. Because the anode chamber of the stack contains enough H₂, this process will not cause any damage to the stack.

In the above Examples 2, 3 and 4, since the stack-H₂-inlet solenoid valve is kept in the opened state, the O₂ remaining in the cathode chamber can be quickly consumed by using an external power source. The external power source applies a voltage of around 50 mV on each anode and 0 mV on each cathode within the stack. The H₂ at the anode is oxidized to electrons and protons as shown by Reaction (3); they move to the cathode to react with O₂ to form water as shown by Reaction (2). The entire process is shown in FIG. 19. The entire process only needs about 1 minute.

It is not possible to list all the procedures to carry out this invention. All the above examples are for the purpose of illustrations only, and they should not be used as limitations to the current invention. Based on the description and examples in this invention, ordinary technical personnel in this area can figure out many variations, and all those variations are within the scope of this invention.

1. A method to enhance lifetime of fuel cells comprising a step of: creating a H₂ environment for a stack of the fuel cell when the fuel cell is in an idling state or in a shutdown state before a next startup thereof, the H₂ environment is composed of H₂ confined within a gas-tight enclosure.

2-21. (canceled)

22. The method, as recited in claim 1, wherein when the fuel cell is in the idling state or in the shutdown state, a stack-air-inlet, a stack-air-outlet, and a stack-H₂-outlet of the stack are in a closed state, while a stack-H₂-inlet of the stack is in an opened state.

23. The method, as recited in claim 1, wherein when the fuel cell is in the idling state or in the shutdown state, a stack-air-inlet, a stack-air-outlet, and a stack-H₂-outlet of the stack are in a closed state, while a stack-H₂-inlet of the stack is in the opened state for 10-20 minutes before it is closed.

24. The method, as recited in claim 1, wherein the H₂ environment has an absolute pressure larger than 1 atmosphere.

25. The method, as recited in claim 1, further comprising a step of: when the fuel cell is in the idling state or in the shutdown state, applying a dummy or auxiliary load to the stack to quickly consume O₂ remaining in a cathode chamber of the stack.

26. The method, as recited in claim 1, further comprising a step of: when the fuel cell is in the idling state or in the shutdown state, applying a flow of H₂ into to a cathode chamber of the stack to force out O₂ remaining in the cathode chamber of the stack.

27. The method, as recited in claim 1, further comprising a step of: when the fuel cell is in the idling state or in the shutdown state, applying an external power source to the stack to quickly consume O₂ remaining in a cathode chamber of the stack.

28. A device for enhancing lifetime of at least a fuel cell, comprising:
a gas-tight enclosure, having a plurality of pipeline openings, for placing a stack of fuel cell therein;
an enclosure-H₂-inlet port and an enclosure-H₂-outlet port provided at the gas-tight enclosure to allow communication between an interior of the gas-tight enclosure and an exterior thereof, wherein a H₂ environment is created within the interior of the gas-tight enclosure when the fuel cell is in an idling state or in a shutdown state before a next startup thereof; and
a pipeline for extending through the pipeline openings of the gas-tight enclosure for connecting to the stack, wherein gaps between said pipeline and said pipeline openings are sealed, wherein the pipelines comprises a stack-H₂-inlet, a stack-H₂-outlet, a stack-air-inlet, a stack-air-outlet, a stack-coolant-inlet, and a stack-coolant-outlet for transporting fuel and coolant to the stack correspondingly.

29. The device, as recited in claim 28, further comprising a pressure regulator operatively coupled at the enclosure-H₂-inlet at the exterior of the gas-tight enclosure.

30. The device, as recited in claim 28, further comprising two solenoid valves operatively coupled at the enclosure-H₂-inlet port and the enclosure-H₂-outlet port at the exterior of the gas-tight enclosure respectively.

31. The device, as recited in claim 28, further comprising a H₂ concentration sensor provided within the gas-tight enclosure.

32. The device, as recited in claim 28, further comprising a gas pressure sensor provided within the gas-tight enclosure.

33. The device, as recited in claim 28, wherein the gas-tight enclosure is made of material selected from a group consisting of stainless steel, aluminum or its alloys, and dense polyethylene.

34. The device, as recited in claim 28, wherein a thickness of the gas-tight enclosure is 1 to 3 mm.

35. The device, as recited in claim 28, further comprising an insulating material wrapping around at least an outer surface and an inner surface of the gas-tight enclosure.

36. The device, as recited in claim 28, further comprising a desiccant disposed within the gas-tight enclosure.

37. The device, as recited in claim 28, further comprising a plurality of covers for open-cathode stack, wherein a wider side of each of the covers cover at air channels of the stack and a narrower side of each of the covers sealed with a stack-air-inlet or a stack-air-outlet of the stack.

38. The device, as recited in claim 28, further comprising at least one operable and sealable door provided at the gas-tight enclosure.

39. A method for storing MEAs and stacks by creating a H₂ environment for the MEAs and stacks during their storage, the H₂ environment is composed of H₂ confined within a gas-tight enclosure.

40. A device for storing MEAs and stacks, comprising a gas-tight enclosure for placing the MEAs and the stacks therein;
an enclosure-H₂-inlet port and an enclosure-H₂-outlet port on the said enclosure, wherein a H₂ environment is created within the said enclosure;
a pressure regulator operatively coupled at the enclosure-H₂-inlet at an exterior of the gas-tight enclosure; and
two solenoid valves operatively coupled at the enclosure-H₂-inlet port and the enclosure-H₂-outlet port at the exterior of the gas-tight enclosure respectively.
